(19) United States
(12) Patent Application Publication
(10) Pub. No.: US 2011/0257683 A1
(43) Pub. Date: Oct. 20, 2011

(54) PACIFIER DEVICE AND SYSTEM

(76) Inventor: Paul Dabney, Georgetown, TX (US)

(21) Appl. No.: 13/086,474

(22) Filed: Apr. 14, 2011

Related U.S. Application Data
(60) Provisional application No. 61/323,964, filed on Apr. 14, 2010.

(51) Int. Cl. A61J 17/00

(52) U.S. Cl. 606/234

(57) ABSTRACT

A pacifier system to help a child break a habit of using standard pacifiers includes a first pacifier, having a first nipple with a nipple shape and a first nipple size; and a second pacifier, having a second nipple with substantially the same nipple shape and a second nipple size. The second nipple size is smaller than the first nipple size. The pacifiers may have different size codes for nipples with different diameters.

### RELATED APPLICATIONS

This application claims the benefit of the filing date of U.S. Patent Application No. 61/323,964, filed Apr. 14, 2010, which is incorporated herein by reference in its entirety.

### BACKGROUND OF THE INVENTION

The present invention generally relates to pacifiers and more specifically to a pacifier system.

Children reach an age where the use of a pacifier is an inconvenience, as well as potentially harmful to the development of the teeth and oral tissues.

It would be desirable to help a child break the habit of using a standard pacifier.

### SUMMARY OF THE INVENTION

In one aspect of the present invention, a pacifier system to help a child break a habit of using standard pacifiers includes a first pacifier, having a first nipple with a nipple shape and a first nipple size; and a second pacifier, having a second nipple with substantially the same nipple shape and a second nipple size; wherein the second nipple size is smaller than the first nipple size.

In another aspect of the present invention, a set of pacifiers to prevent problems associated with the use of pacifiers includes a plurality of pacifiers, each pacifier having a plate, a knob, and a nipple; wherein each pacifier is size coded; and wherein each nipple has a size different from the size of the other nipples.

In yet another aspect of the present invention, a method of helping a child break a habit of using standard pacifiers includes providing a first pacifier to the child, having a first nipple with a nipple shape and a first nipple size; and providing subsequent pacifiers to the child, having subsequent nipples with substantially the same nipple shape and a subsequent nipple size that is smaller than the nipple of the previous pacifier.

### BRIEF DESCRIPTION OF THE DRAWINGS

FIG. 1 illustrates a perspective view of a pacifier according to the present invention;

FIG. 2 illustrates a top view of the embodiment of a pacifier of FIG. 1;

FIG. 3 illustrates a side view of the embodiment of a pacifier of FIG. 1; and

FIG. 4 illustrates a pacifier system having three pacifiers according to the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a set of pacifiers designed to help a child break the habit of using a standard pacifier.

A set of pacifiers according to the present invention may include a plurality of pacifiers that helps prevent the problems associated with the use of pacifiers.

An embodiment of a decorative knob may be the outer part of the pacifier in relation to the user's mouth and may be approximately 3 centimeters in diameter and 0.5 centimeters in thickness. Embodiments of knob may be designed to offer aesthetics to the design of the pacifier. This may be accomplished by using varying colors and/or patterns in its design.

In an embodiment, between the knob and the child's mouth may be a plate curved to match the curvature of the mouth and to secure the pacifier's position in the mouth. The plate may be approximately 2 mm thick, 3 cm high and 5 cm in width. The plate may offer resistance to the sucking action that a child exerts on a pacifier.

Attached to the plate and knob may be a nipple designed for a child to suck on. The nipple may be the only part of the pacifier that rests inside the user's mouth. The nipple may be designed to stimulate the normal sucking action observed in the child. The nipples on different pacifiers in the system may have substantially the same shape, so as to be suitable as pacifiers, but be of different sizes.

In an embodiment, a knob and plate may be made of injection molded plastic. A nipple may also be made of injection molded, pliable plastic.

An embodiment of a pacifier may be size coded. For example, the higher the number on the pacifier, the shorter the nipple, and the smaller the diameter of the nipple. By sequentially making the nipples smaller, the user may experience a gradual reduction in the satisfaction produced by the pacifier's use. The series of pacifiers may provide a gradual reduction in the user's satisfaction that is received from its sequential use. The reduction in satisfaction would enable the child to break the habit associated with pacifier use.

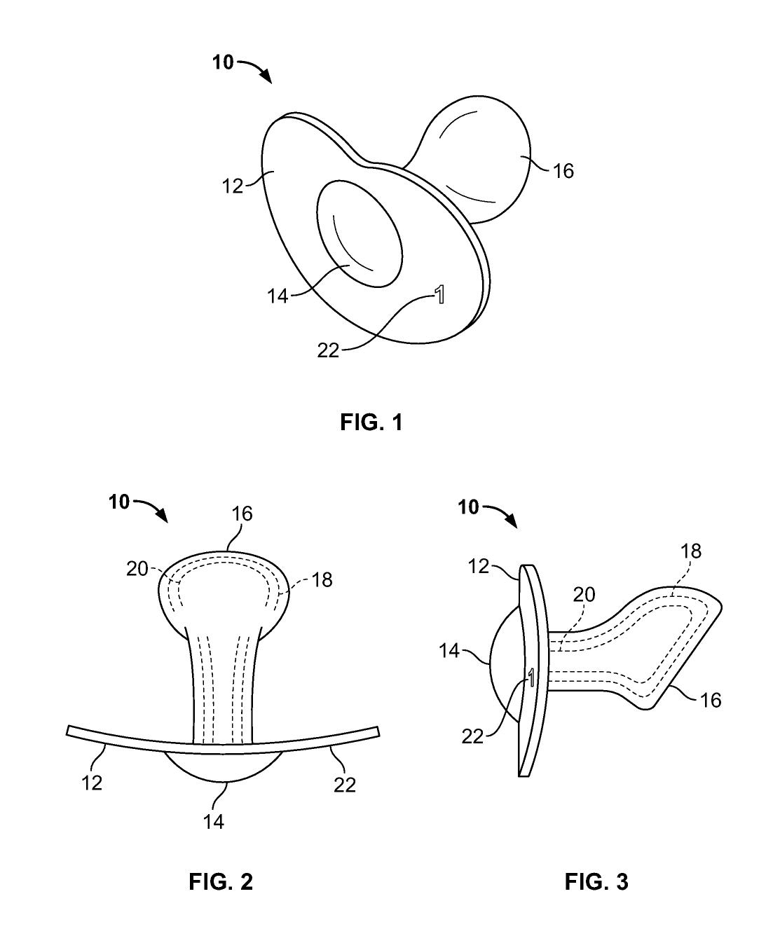

As depicted in the embodiment of FIG. 1, a pacifier 10 may include a knob 14, a plate 12, and a nipple 16. Pacifier 10 may have a size-code indicator 22, which may be on the plate 12 or another part of the pacifier 10.

As depicted in the embodiments of FIGS. 2 and 3, embodiments of a pacifier 10 may have a nipple 16 with a first size, a nipple 18 with a second size, or a nipple 20 with a third size. The pacifier 10 may have a size-code indicator 22 that indicates the size of the nipple.

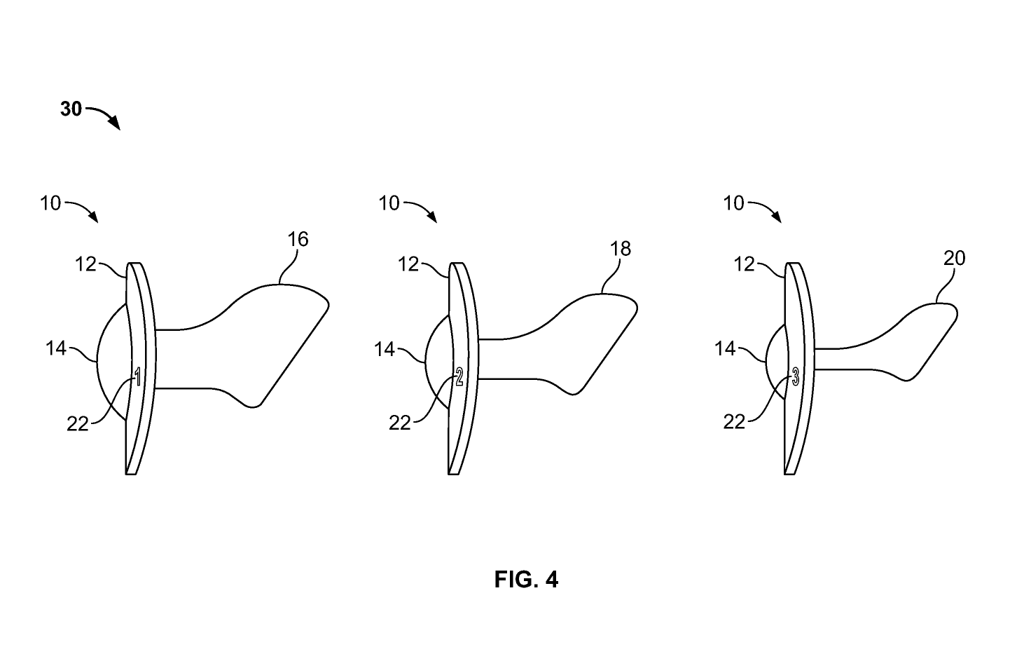

As depicted in the embodiment of FIG. 4, a pacifier system 30 may include a set of three pacifiers, each having a nipple with a different size (nipples 16, 18, and 20). The pacifiers may have size-code indicators, such as 1, 2, 3, respectively. Other embodiments may have other numbers of pacifiers of different sizes. Each pacifier could be, for example, approximately 2 mm shorter and 1 mm narrower than its predecessor. Pacifiers may be numbered with the beginning pacifier numbered 1 and each subsequent, smaller pacifier being numbered 1 higher than its predecessor. The nipples 16, 18, 20 may have substantially the same shape, so that they can be used as pacifiers for a child.

To use an embodiment of an example pacifier system having five pacifiers, a child could use each of the pacifiers, numbered 1 through 5, in order, for about one week each. The final pacifier could be discarded after 1 week and all pacifier use is discontinued. The sequentially smaller nipples associated with each higher numbered nipple may help plan and provide the pacifiers to the child in the proper order.

An embodiment may include a set of pacifiers to prevent problems associated with the use of pacifiers, the set comprising: a plurality of pacifiers, each pacifier having a plate, a knob, and a nipple; wherein each pacifier is size coded; and wherein each nipple has a size different from the size of the other nipples.

I claim:

1. A pacifier system to help a child break a habit of using standard pacifiers, comprising:
a first pacifier, having a first nipple with a nipple shape and a first nipple size; and
a second pacifier, having a second nipple with substantially the same nipple shape and a second nipple size;
wherein the second nipple size is smaller than the first nipple size.

2. The system of claim 1, wherein the first nipple has a first diameter that is different from a second diameter of the second nipple.

3. The system of claim 1, further comprising:
a first size code on the first pacifier that indicates the first nipple size; and
a second size code on the second pacifier that indicates the second nipple size.

4. The system of claim 1, wherein each pacifier further comprises:
a plate attached to the nipple, curved to match the curvature of the child's mouth and to secure the pacifier's position in the child's mouth.

5. The system of claim 4, further comprising:
a knob attached to the plate.

6. The system of claim 1, wherein
the first pacifier further comprises a first plate attached to the first nipple;
the second pacifier further comprises a second plate attached to the second nipple; and
the first plate and the second plate have substantially the same size and shape.

7. The system of claim 1, wherein each nipple further is substantially made of injection molded, pliable plastic.

8. The system of claim 1, further comprising:
a third pacifier having a third nipple size, smaller than the second nipple size; and
the pacifiers each have a size code that increases as the nipple size decreases.

9. A set of pacifiers to prevent problems associated with the use of pacifiers, the set comprising:
a plurality of pacifiers, each pacifier having a plate, a knob, and a nipple;
wherein each pacifier is size coded; and
wherein each nipple has a size different from the size of the other nipples.

10. A method of helping a child break a habit of using standard pacifiers, comprising:
providing a first pacifier to the child, having a first nipple with a nipple shape and a first nipple size; and
providing subsequent pacifiers to the child, having subsequent nipples with substantially the same nipple shape and a subsequent nipple size that is smaller than the nipple of the previous pacifier.

11. The method of claim 10, wherein the first pacifier and the subsequent pacifiers have nipples with different diameters.

12. The method of claim 10, wherein the first pacifier and the subsequent pacifiers have nipples with smaller sizes that provide a gradual reduction in the satisfaction produced by the pacifier's use.

13. The method of claim 10, wherein the pacifiers are size-coded, and each nipple has a size different from the size of the other nipples.

14. The method of claim 10, wherein the first pacifier and the subsequent pacifiers have nipples with smaller sizes and increasing size codes.
